(19) United States
(12) Patent Application Publication
(10) Pub. No.: US 2015/0075042 A1
(43) Pub. Date: Mar. 19, 2015

(54) DOCUMENT DISPLAY SYSTEMS

(71) Applicant: Justin Ebensteiner, Olympia, WA (US)

(72) Inventor: Justin Ebensteiner, Olympia, WA (US)

(21) Appl. No.: 14/026,905

(22) Filed: Sep. 13, 2013

(51) Int. Cl. B60Q 1/56; B60R 13/10

(52) U.S. Cl. CPC B60Q 1/56; B60R 13/10; G09F 2013/1881
USPC 40/204; 40/714

(57) ABSTRACT

Document display systems including an enclosure including a first surface, a second surface spaced from the first surface, a top edge connecting the first surface and the second surface, a bottom edge opposite the top edge and connecting the first surface and the second surface, a first lateral side connecting the first surface, the second surface, the top edge, and the bottom edge, a second lateral side opposite the first lateral side connecting the first surface, the second surface, the top edge, and the bottom edge, and a cavity bounded by the first surface, the second surface, the top edge, the bottom edge, the first lateral side, and the second lateral side; a light source mounted within the cavity; and a fastener removably attached to the first surface and configured to selectively fasten the enclosure to a window of a vehicle.

### BACKGROUND

The present disclosure relates generally to document display systems. In particular, document display systems including internal cavities illuminated by light emitting diodes are described.

Known document display systems are not entirely satisfactory for the range of applications in which they are employed. For example, existing document display systems lack the convenience, illuminating features, and universal nature of the present invention.

Conventional document display systems are inconvenient. Typically, when a vehicle is purchased, a temporary license “plate” must be displayed the rear window of the vehicle. The temporary license “plate” is most often a paper document and is adhered to the window using tape or an adhesive compound. Undesirably, a sticky residue remains after the paper document is removed; the sticky reside is difficult to remove and can remain on the window for years. Unsightly sticky residue is just one inconvenient consequence of using conventional document displays.

Moreover, adhering a paper document to a vehicle's rear window is undesirable because the existing paper document is un-illuminated. Normally, a rear license plate of a vehicle is illuminated. However, temporary vehicle registrations taped to the vehicle's rear window often go unnoticed or are illegible in low light conditions due to lack of illumination. Existing, un-illuminated paper documents are difficult for law enforcement personnel to read, which can lead to unnecessary investigative traffic stops. Unnecessary investigative traffic stops are a nuisance for lawful drivers and create an inconvenience for law enforcement personnel.

Some conventional document display systems are capable of universally mounting to the exterior of a vehicle. For example, magnetic display systems exist that are utilized for adhering a metal license plate to a vehicle during test-drives. Typically, a vehicle dealer will magnetically attach a “dealer plate” to the rear of a vehicle so a potential purchaser may test-drive the vehicle.

However, the existing method of magnetically attaching a license plate to the exterior of a vehicle is undesirable for several reasons: the magnet may detach causing the plate to become lost or stolen, the plate or magnet may disfigure the vehicle surface, the plate is not protected from adverse weather, and existing magnetic attachment mechanisms additionally lack illuminating features.

Further, conventional document display systems lack the ability to concurrently display dealership information or advertising information. Conventional document display systems are rudimentary and accomplish the limited goal of temporarily displaying a vehicle registration or license plate without concurrently displaying information about the vehicle's source.

Thus, there exists a need for document display systems that improve upon and advance the design of known document display systems. Particularly, there exists a need for document display systems that are equally capable of displaying paper documents or metal license plates. Moreover, there exists a need for document display systems that are capable of universally attaching to vehicle window interiors while concurrently communicating advertising messages. Examples of new and useful document display systems relevant to the needs existing in the field are discussed below.

### SUMMARY

The present disclosure is directed to document display systems including an enclosure including a first surface, a second surface spaced from the first surface, a top edge connecting the first surface and the second surface, a bottom edge opposite the top edge and connecting the first surface and the second surface, a first lateral side connecting the first surface, the second surface, the top edge, and the bottom edge, a second lateral side opposite the first lateral side connecting the first surface, the second surface, the top edge, and the bottom edge, and a cavity bounded by the first surface, the second surface, the top edge, the bottom edge, the first lateral side, and the second lateral side; a light source mounted within the cavity; and a fastener removably attached to the first surface and configured to selectively fasten the enclosure to a window of a vehicle. In some examples, the document display system includes a substantially transparent first surface movably connected to a substantially opaque second surface. In some further examples, the document display system includes a hinged top edge that provides access to a cavity illuminated by a plurality of light emitting diodes.

### BRIEF DESCRIPTION OF THE DRAWINGS

FIG. 1 is a front perspective view of a first example of a document display system.

FIG. 2 is a front perspective view of the document display system shown in FIG. 1 depicting a top edge of the document display system including a power switch.

FIG. 3 is a rear perspective view of the document display system shown in FIG. 1 depicting a battery enclosure on a second surface.

FIG. 4 is a front perspective view of the document display system shown in FIG. 1 depicting a first surface in an open configuration and exposing a cavity of the document display system.

FIG. 5 is a top elevation view of the document display system shown in FIG. 1 depicting a plurality of fasteners mounted to the first surface.

FIG. 6 is a bottom elevation view of the document display system shown in FIG. 1 depicting a curved profile of the document display system.

FIG. 7 is a top elevation view of the document display system shown in FIG. 1 depicting a hinged top edge.

FIG. 8 is a front elevation view of the document display system shown in FIG. 1 depicting a temporary vehicle permit retained within the document display system cavity.

FIG. 9 is a front elevation view of the document display system shown in FIG. 1 depicting the document display system mounted on a rear window of a vehicle.

FIG. 10 is a front perspective view of a second example of a document display system including a bottom edge of the document display system including a power switch.

FIG. 11 is a front perspective view of the document display system shown in FIG. 10 depicting a plurality of light emitting diodes mounted within a cavity of the document display system.

FIG. 12 is a front perspective view of the document display system shown in FIG. 10 depicting a first substantially transparent surface in an open configuration.

FIG. 13 is a front perspective view of a third example of a document display system including a hinged top edge.

FIG. 14 is a front perspective view of the document display system shown in FIG. 13 depicting a plurality of light emitting diodes mounted on a bottom edge of an interior cavity of the document display system.

FIG. 15 is a rear perspective view of the document display system shown in FIG. 13 depicting a power switch on a bottom surface of the document display system.

FIG. 16 is a top perspective view of the document display system shown in FIG. 13 depicting the hinged top edge in an open configuration.

FIG. 17 is a front elevation view of the document display system shown in FIG. 13 depicting a plurality of fasteners arranged near outer edges of the document display system.

FIG. 18 is a bottom elevation view of the document display system shown in FIG. 13 depicting a linear profile of the document display system.

FIG. 19 is a top elevation view of the document display system shown in FIG. 13 depicting the hinged top edge.

### DETAILED DESCRIPTION

The disclosed document display systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various document display systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

With reference to FIGS. 1-9, a first example of a document display system, document display system 100, will now be described. Document display system 100 includes an enclosure 110 a light source 130, and a plurality of fasteners 140.

As shown in FIG. 1, enclosure 110 is configured to store documents. Light source 130 is mounted within enclosure 110 and functions to illuminate the contents of enclosure 110. Moreover, plurality of fasteners 140 are mounted on the exterior of enclosure 110. Plurality of fasteners 140 facilitate or allow mounting enclosure 110 to vehicle windows.

Document display system 100 functions to display documents. Particularly, document display system 100 functions to display documents, including temporary vehicle registrations, on vehicles. Additionally or alternatively, document display system 100 can be used to display vehicle manufacturers' specification documents, buyer's guides, “For Sale” signs, and license plates.

Document display system 100 improves upon and advances the design of known document display systems. Document display system 100 provides a convenient, universally mountable, illuminating enclosure for displaying documents and license plates on vehicles.

Document display system 100 conveniently adheres to any interior window of a vehicle. Unlike existing methods of displaying temporary permits, plurality of fasteners 140 removably mount document display system 100 to vehicle windows without adhesives. Thus, document display system 100 does not deposit the unsightly and difficult-to-remove residue of conventional document display methods.

Further, plurality of fasteners 140 universally mount document display system 100 to the interior surface of any vehicle window. Accordingly, document display system 100 may be used to display a temporary vehicle registration or dealer license plate in the rear window of a vehicle. Additionally, document display system 100 may be used to display vehicle specification information or vehicle buyers' guides on side windows. Still further, document display system 100 may be configured to display a “For Sale” sign or additional advertising information concurrent with internally contained documents.

Mounting document display system 100 to the interior of vehicle windows is superior to existing document display methods, because document display system 100 prevents loss or theft of the displayed document. Further, document display system 100 eliminates the possibility of damaging or disfiguring the exterior surface of the vehicle posed by conventional document display methods.

Moreover, light source 130 illuminates documents contained within document display system 100. Unlike conventional un-illuminated document displays, document display system 100 provides a reliable means of illuminating temporary registrations and license plates.

As can be seen in FIG. 1, enclosure 110 includes a first surface 112, a second surface 114 spaced from first surface 112, a top edge 111 connecting first surface 112 and second surface 114, and a bottom edge 113 (opposite top edge 111) connecting first surface 112 and second surface 114.

In the FIG. 1 example, enclosure 110 is comprised of plastic. Alternatively, the enclosure may be comprised of any now known or later developed material suitable for comprising enclosures. Suitable enclosure materials include, but are not limited to, wood, metal, rubber, vinyl, carbon fiber, and composites.

In the example shown in FIG. 1, enclosure 110 is rectangular. Alternatively, the enclosure may be configured in any shape or form suitable for displaying documents, including, but not limited to, circular, square, ovoid, trapezoidal, and triangular.

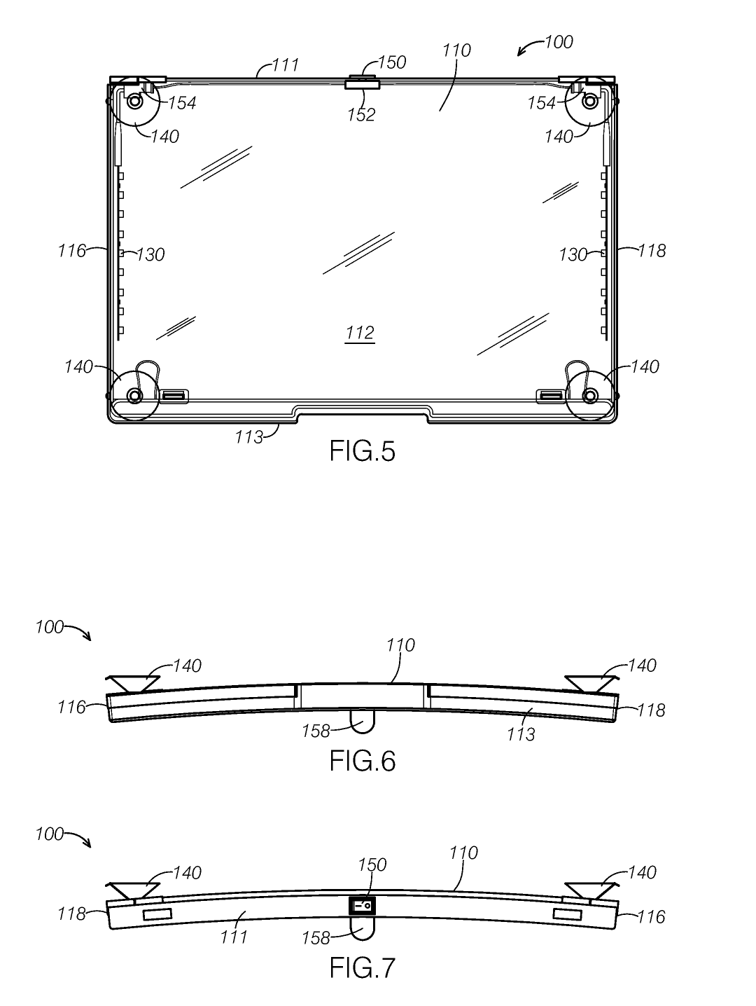

As shown most clearly in FIGS. 6 and 7, the profile of enclosure 110 may be curved to facilitate or allow mounting on vehicle windows. Alternatively, the profile of the enclosure may be formed in any manner or configuration that facilitates or allows mounting on vehicle windows. Suitable enclosure profile configurations include, but are not limited to, linear, wedge-shaped, and semi-circular.

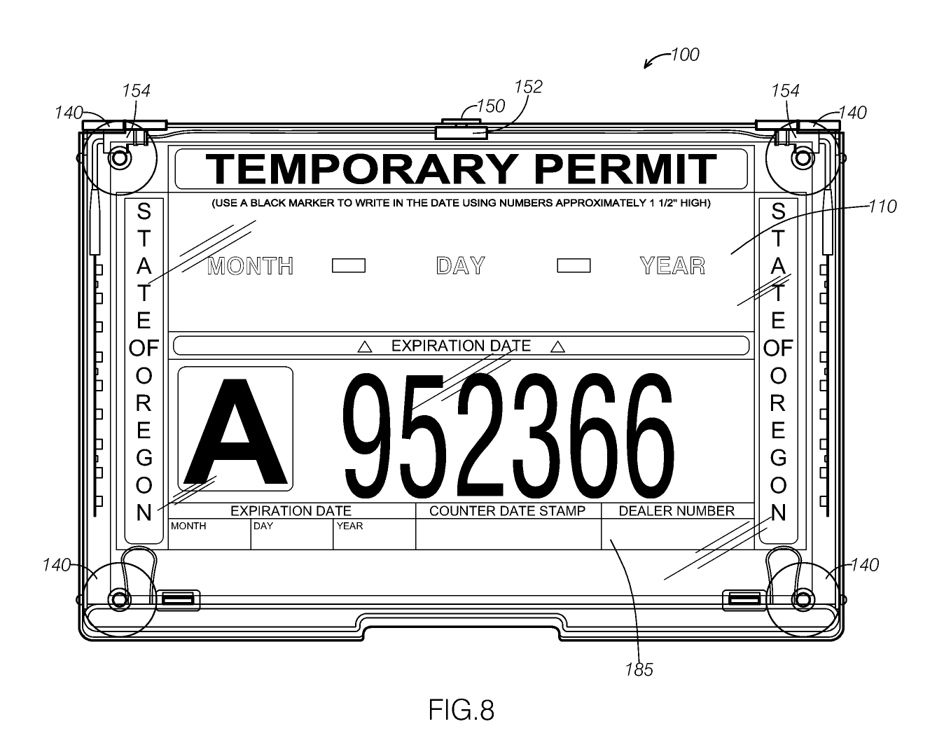

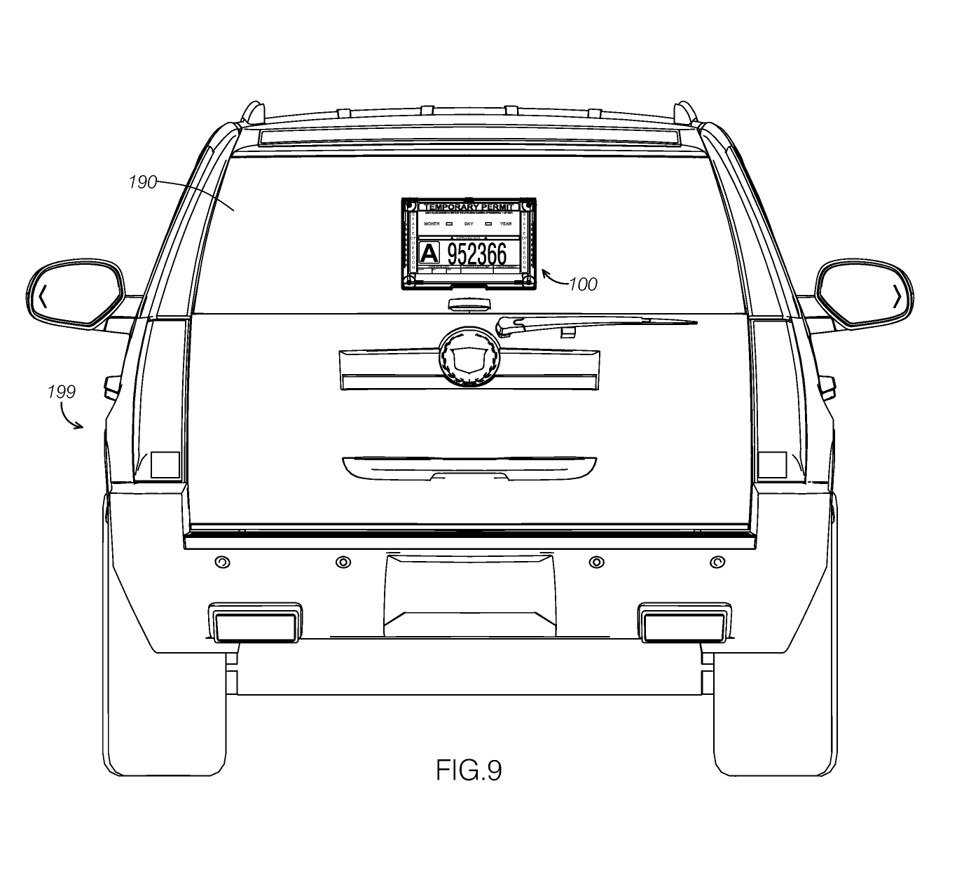

As shown most clearly in FIG. 8, first surface 112 is configured to facilitate or allow viewing of the contents of enclosure 110. First surface 112 comprises the “front” of enclosure 110. First surface 112 is located proximate to a vehicle's window when enclosure 110 is mounted on the window.

In the FIG. 8 example, first surface 112 is substantially transparent. Alternatively, the first surface may be translucent, darkened, or opaque. Additionally or alternatively, the first surface may incorporate document preserving features such as UV-shielding.

Additionally or alternatively, the first surface may include identifying information. Methods of including identifying information include, but are not limited to, holographing, frosting, and engraving. For example, the first surface may include holographic, frosted, or engraved vehicle dealership catch phrases, logos, or contact information.

In the FIG. 1 example, first surface 112 is comprised of clear plastic. Alternatively, the first surface may be comprised of any now known or later developed material suitable for displaying documents. Suitable first surface materials include, but are not limited to, glass, polyester, nylon, rubber, and Plexiglas®.

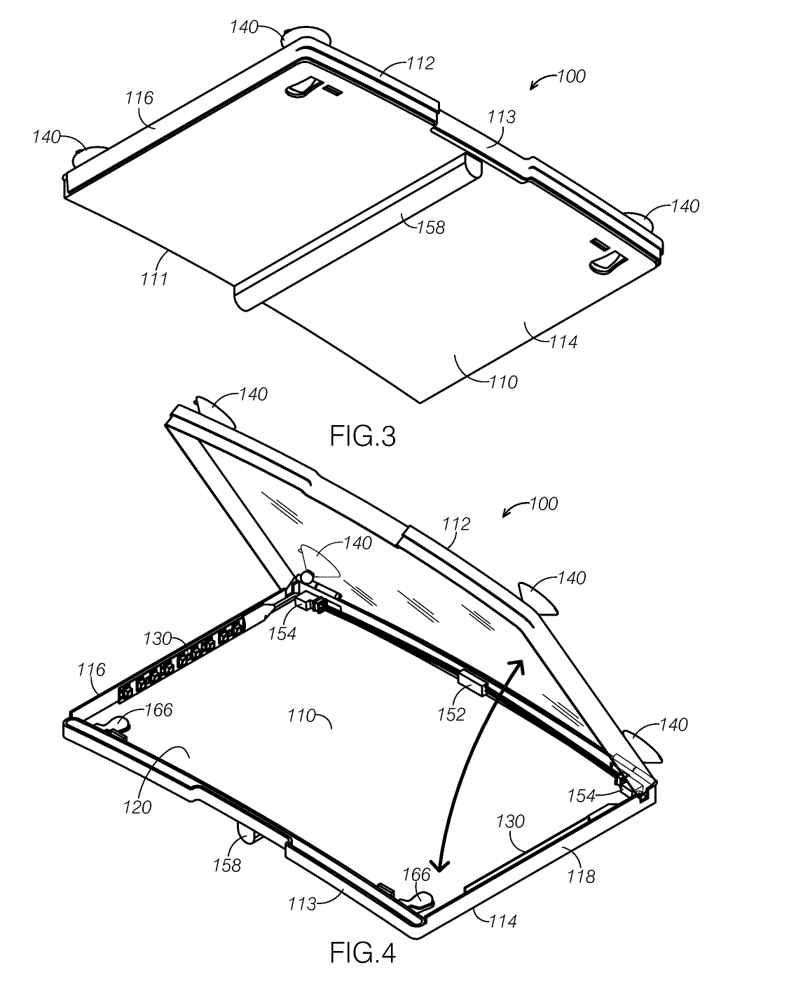

As show in FIGS. 1 and 3, second surface 114 is spaced from and substantially aligned with first surface 112. Second surface 114 comprises the “back” of enclosure 110. Second surface 114 is located distal from a vehicle's window when enclosure 110 is mounted on the window.

In the FIG. 3 example, second surface 114 is opaque. Alternatively, the second surface may be transparent, translucent, or darkened.

Additionally or alternatively, the second surface may include identifying information. The methods of including identifying information on the first surface listed above are also suitable for including information on the second surface. The second surface may include vehicle dealership catch phrases, logos, or contact information.

In the FIG. 3 example, second surface 114 is comprised of opaque plastic. Alternatively, the second surface may be comprised of any now known or later developed material suitable for displaying documents. Suitable second surface materials include, but are not limited to, glass, polyester, nylon, rubber, and Plexiglas®.

As shown most clearly in FIG. 3, second surface 114 includes a battery enclosure 158. Battery enclosure 158 is configured to house batteries to power light source 130. Additionally, battery enclosure 158 is configured to facilitate or allow manipulating and moving enclosure 110. In other words, battery enclosure 158 forms a point of contact convenient for gripping by a human hand.

In the FIG. 3 example, battery enclosure 158 is located on second surface 114. Alternatively, the battery enclosure may be arranged in any location on the enclosure.

Also shown in the FIG. 3 example, battery enclosure 158 is oblong. Alternatively, the battery enclosure may be configured in any shape or form that facilitates or allows storing a power source sufficient to power the light source.

Rather than including a battery enclosure, the document display system may include alternative means of powering the light source. Acceptable alternative sources of power include, but are not limited to, solar cells, and 12-volt connectors.

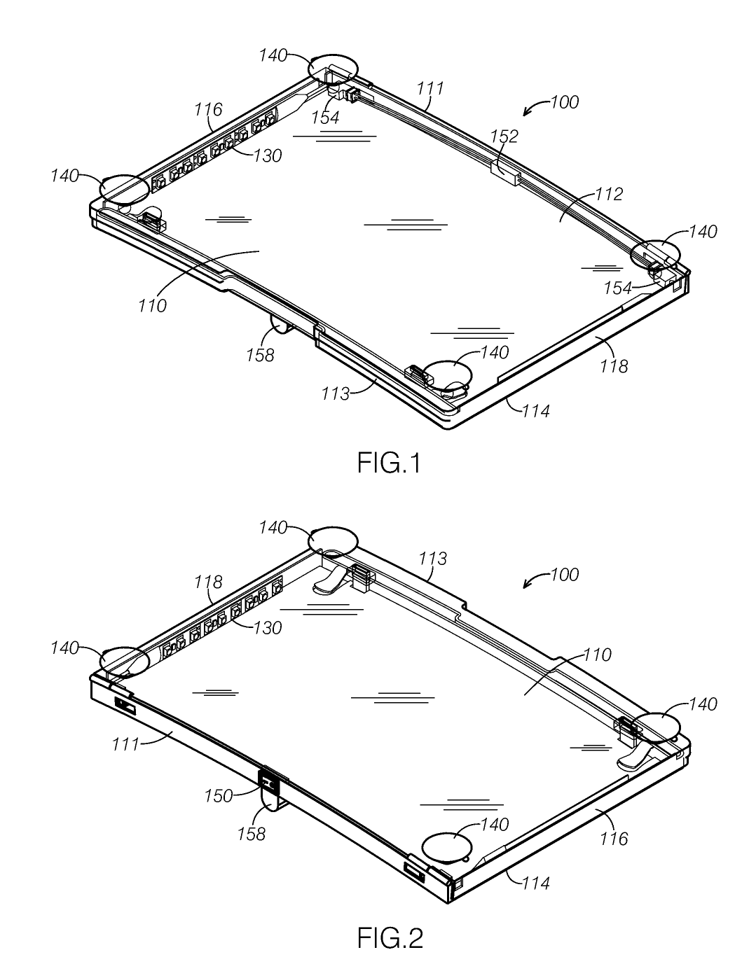

As shown in FIGS. 2, 4, and 7, top edge 111 forms the “top” of enclosure 110. As shown most clearly in the FIG. 4 example, top edge 111 is hinged and facilitates or allows first surface 112 to rotate or pivot away from second surface 114.

Also shown in FIG. 2, top edge 111 includes a switch 150. Switch 150 is configured to power light source 130 “on” or “off.” In the example shown in FIG. 2, switch 150 is configured as a fulcrum-type switch. Alternatively, the switch may be configured in any shape or form that facilitates or allows selectively powering the light source “on” or “off.” Acceptable switch configurations include, but are not limited to, toggle switches, push buttons, and slides.

Alternatively, a switch may not be included on the enclosure. Rather, the light source can be configured to power “on” or “off” automatically through a timer, an ambient light sensor, or other automatic means of power activation and deactivation.

As shown in FIG. 1, a controller 154 powers light source 130 “on” or “off.” Controller 154 is configured to activate switch 150 to power light source 130 “on,” and deactivate switch 150 to power light source 130 “off.”

In the FIG. 1 example, controller 154 is located inside enclosure 110. Alternatively, the controller may be located on an exterior surface or edge of the enclosure.

Also shown in FIG. 1, a sensor 152 is configured to detect ambient daylight. In the FIG. 1 example, sensor 152 is configured to cooperatively facilitate or allow powering light source 130 “on” or “off.” In other words, with switch 150 in the “on” position, when sensor 152 detects a threshold of ambient daylight, controller 154 will deactivate switch 150 to power light source 130 “off.” Moreover, with switch 150 in the “off” position, when sensor 152 fails to detect a threshold of ambient daylight, controller 154 will activate switch 150 to power light source 130 “on.”

In the FIG. 1 example, sensor 152 cooperates with controller 154. Alternatively, the controller may cooperate with a timer to power the light source “on” or “off” at a pre-determined time of day. For example, the controller may power the light source “on” at 7 p.m. and “off” at 7 a.m.

As shown in FIG. 1, sensor 152 is located inside enclosure 110. Alternatively, the sensor may be located on an exterior surface or edge of the enclosure, or any location that facilitates or allows the sensor to detect a threshold of ambient light.

As shown in FIGS. 1, 3, 4, and 6, bottom edge 113 forms the “bottom” of enclosure 110. Bottom edge 113 is molded to facilitate or allow manipulating and moving enclosure 110. Bottom edge is non-fixed to facilitate or allow first surface 112 to rotate or pivot away from second surface 114.

Further, as can be seen in FIG. 1, enclosure 110 includes a first lateral side 116 and a second lateral side 118 opposite first lateral side 116. First lateral side 116 connects first surface 112, second surface 114, top edge 111, and bottom edge 113. Second lateral side 118 also connects first surface 112, second surface 114, top edge 111, and bottom edge 113.

As shown most clearly in FIG. 4, enclosure 110 includes a cavity 120 bounded by first surface 112, second surface 114, top edge 111, bottom edge 113, first lateral side 116, and second lateral side 118. Cavity 120 is configured to receive and display documents.

In the example shown in FIG. 1, cavity 120 is shaped substantially similar to the shape of enclosure 110. Alternatively, the cavity may be shaped to compliment the shape of the enclosure or contrast with the shape of the enclosure. The cavity may be configured in any shape suitable for displaying documents, including, but not limited to, circles, squares, ovals, trapezoids, and triangles.

As shown in FIGS. 1 and 2, light source 130 is mounted within cavity 120. Light source 130 is configured to illuminate the contents of cavity 120. In the FIG. 1 example, light source 130 is comprised of a plurality of light emitting diodes (LEDs). LEDs are particularly effective and desirable as a light source because of limited power requirement and usage. Additionally or alternatively, any now know or later developed light source suitable for illuminating the contents of the cavity may be used.

As shown most clearly in FIG. 4, cavity 120 includes a plurality of retainers 166. Retainers 166 are configured to retain or hold the contents of cavity 120. In the FIG. 4 example, retainers 166 are configured as tension tabs. Additionally or alternatively, the retainers may be configured in any shape or form that allows retaining or holding of the cavity contents. Acceptable retainers include, but are not limited to ties, bands, corner slots, and clips.

As shown in FIGS. 1 and 9, plurality of fasteners 140 are configured to selectively fasten enclosure 110 to a window 190 of a vehicle 199. In the FIG. 1 example, plurality of fasteners 140 are removably attached substantially near the corners of first surface 112. Alternatively, the fasteners may be fixedly or removably attached to the enclosure in any manner sufficient to facilitate or allow selectively fastening the enclosure to a vehicle window.

As shown in the FIG. 1 example, plurality of fasteners 140 are suction-type fasteners. Additionally or alternatively, the fasteners may be configured as any now known or later developed fastening mechanism, including, but not limited to hooks, clasps, clamps, and magnets.

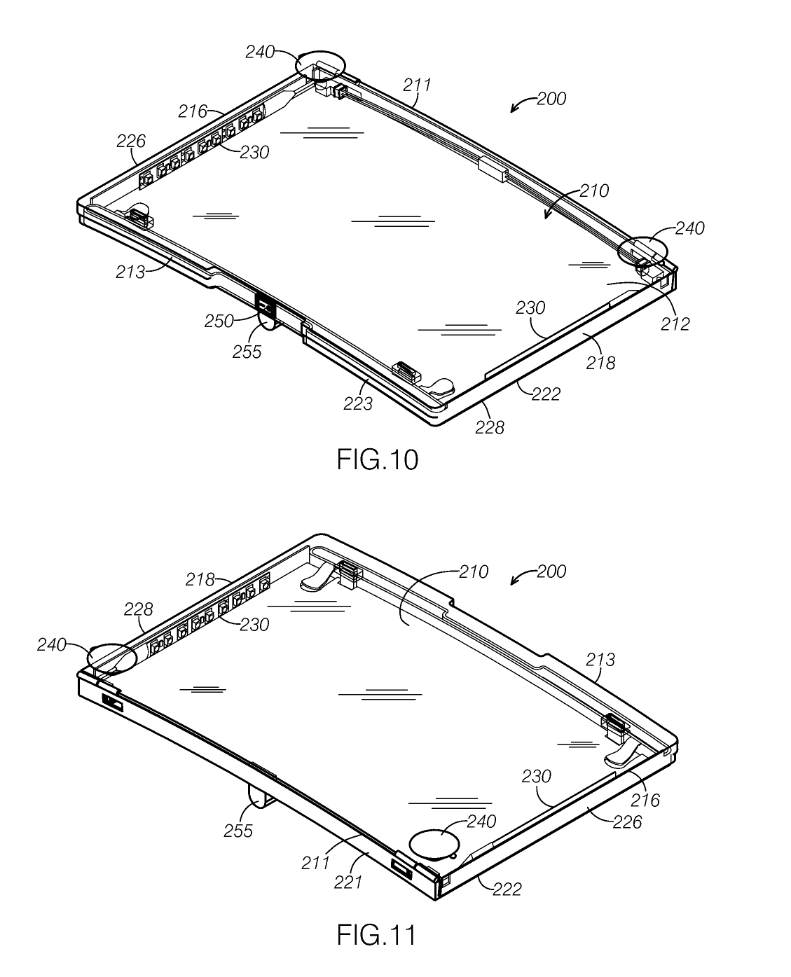

Turning attention to FIGS. 10-12, a second example of a document display system, document display system 200, will now be described. Document display system 200 includes many similar or identical features to document display system 100. Thus, for the sake of brevity, each feature of document display system 200 will not be redundantly explained. Rather, key distinctions between document display system 200 and document display system 100 will be described in detail and the reader should reference the discussion above for features substantially similar between the two document display systems.

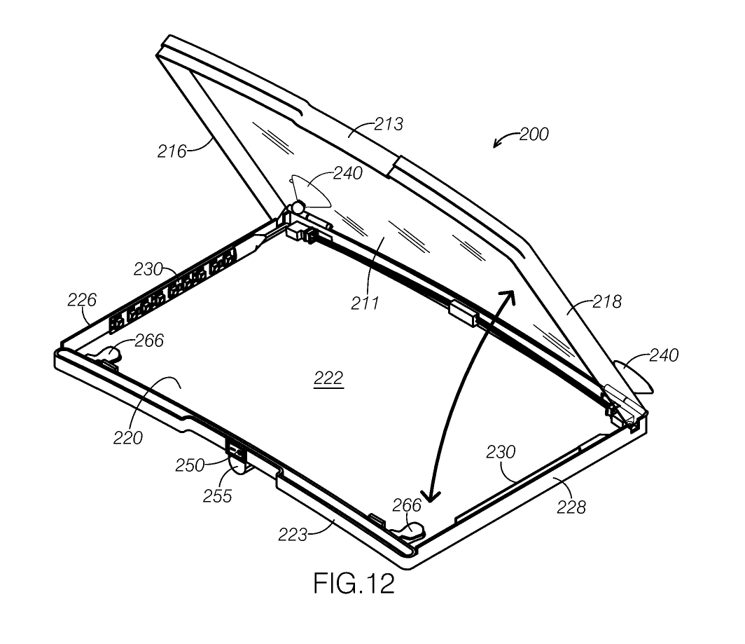

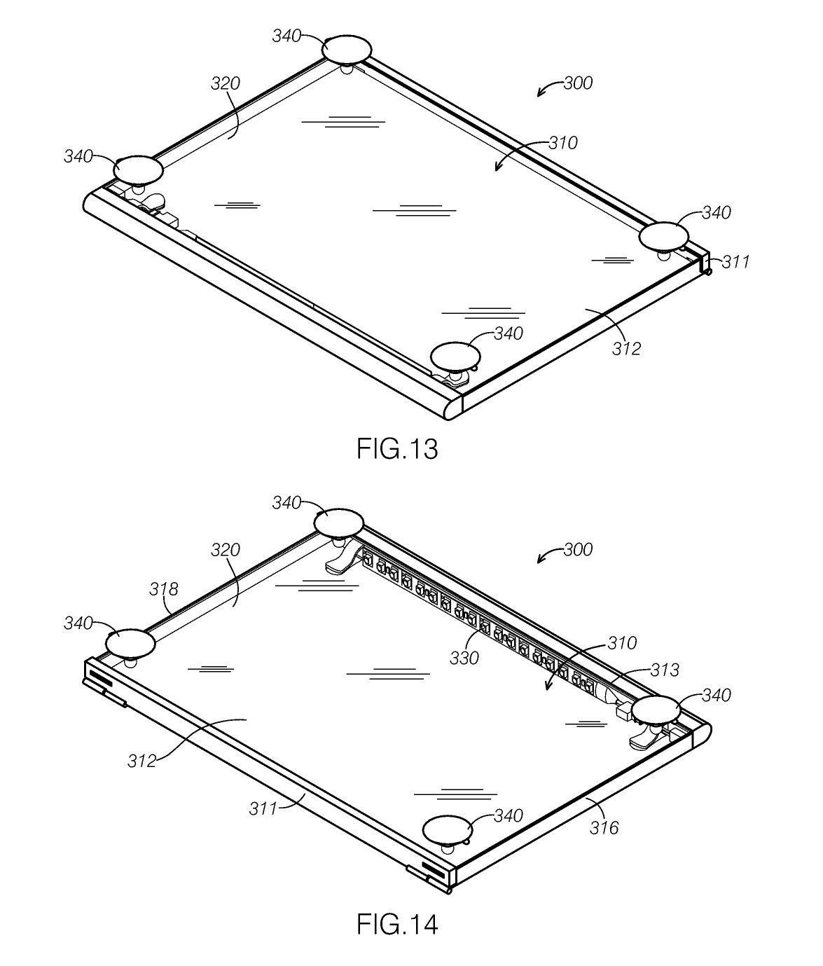

As can be seen in FIG. 12, document display system 200 includes an enclosure 210, a light source 230 mounted within enclosure 210, and a plurality of suction cup fasteners 240 mounted to enclosure 210.

As shown most clearly in FIG. 12, enclosure 210 includes a first substantially transparent surface 212. Further, first substantially transparent surface 212 includes a top edge 211, a bottom edge 213 opposite top edge 211, a first lateral side 216 connecting top edge 211 and bottom edge 213, and a second lateral side 218 (opposite first lateral side 216) connecting top edge 211 and bottom edge 213.

Also shown in FIG. 12, enclosure 210 includes a second substantially opaque surface 222 spaced from and substantially aligned with first substantially transparent surface 212. Additionally, second substantially opaque surface 222 includes an upper edge 221, a lower edge 223 opposite upper edge 221, a primary lateral side 226 connecting upper edge 221 and lower edge 223, and a secondary lateral side 228 (opposite primary lateral side 226) connecting upper edge 221 and lower edge 223.

As can be seen in FIG. 12, top edge 211 is pivotally connected to upper edge 221. Top edge 211 and upper edge 221 are pivotally connected by hinges. Alternatively, the top edge and the upper edge may be cooperatively connected by any now know or later developed mechanism that allows the edges to move relative to each other. Acceptable cooperative mechanisms include, but are not limited to swivels, slides, clips, and clamps.

Additionally, as shown in FIG. 12, first lateral side 216 cooperatively couples with primary lateral side 226, and second lateral side 218 cooperatively couples with secondary lateral side 228. In the FIG. 12 example, the sides cooperatively couple by overlapping. Alternatively, the sides may cooperatively couple by any now known or later developed mechanism that facilitates or allows the enclosure to display documents. The sides may snap together, clamp together, or clasp together.

In the example shown in FIG. 12, bottom edge 213 cooperatively couples with lower edge 223. Bottom edge 213 rests in a recess of lower edge 223. Alternatively, the bottom edge and the lower edge may cooperatively couple by any now known or later developed mechanism that facilitates or allows the enclosure to display documents. The bottom edge and the lower edge may snap together, clamp together, or clasp together.

As shown in FIG. 12, a cavity 220 is bounded by first surface 212 and second surface 222. Cavity 220 is configured to receive and display a document within enclosure 210.

As seen in FIG. 12, cavity 220 includes light sources 230 proximate primary lateral side 226 and secondary lateral side 228. Additionally or alternatively, light sources may be arranged at any location or position to facilitate or allow illuminating cavity 220.

Also shown in FIG. 12, cavity 220 includes retainers 266. Retainers 266 are configured to retain or hold the contents of cavity 220. In the FIG. 12 example, retainers 266 are located proximate lower edge 223. Alternatively, the retainers may be located at a plurality of locations suitable for retaining documents within the cavity.

As shown in FIG. 10, lower edge 223 includes switch 250 configured to power light source 230 “on” and “off.” In the FIG. 10 example, switch 250 is a push button. Alternatively, the switch may be configured in any shape or form that facilitates or allows selectively powering the light source “on” or “off” as discussed above.

As shown in FIG. 11, second surface 222 includes programmable timer 255. Programmable timer 255 is configured to power light source 230 “on” and “off” at a time pre-determined by a user of document display system 200. Alternatively, the programmable timer may be configure to automatically power the light source “off” after a pre-determined time interval has elapsed. For example, the programmable timer may be programmed to power the light source “off” 2 hours after the switch powers the light source “on.”

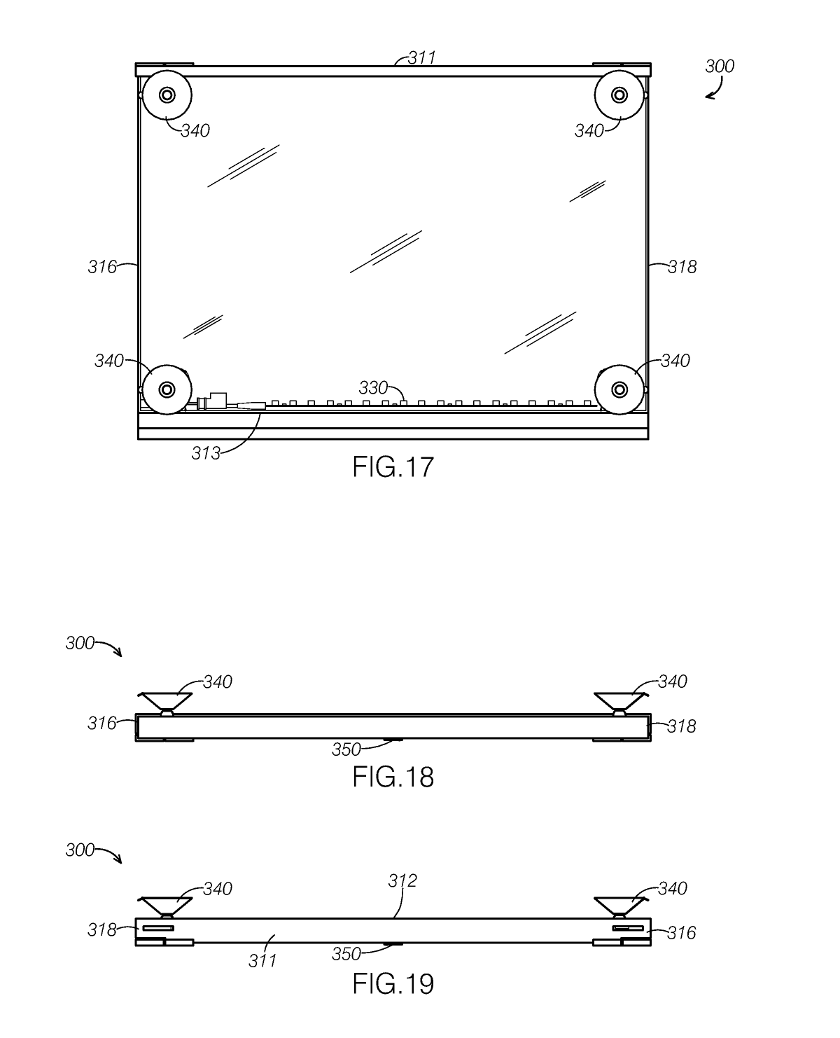

Turning attention to FIGS. 14-19, a third example of a document display system, document display system 300, will now be described. Document display system 300 includes a substantially rectangular transparent enclosure 310 including an interior cavity 320, a plurality of light emitting diodes 330 mounted within the interior cavity, and a plurality of fasteners 340 mounted to an exterior surface 312 of enclosure 310.

As shown most clearly in FIG. 16, enclosure 310 includes a hinged top edge 311, which provides access to interior cavity 320. Top edge 311 is hinged distal from exterior surface 312 so that top edge 311 swivels down and away from exterior surface 312. Alternatively, the top edge may be anchored or hinged on either lateral side of the substantially rectangular transparent enclosure.

In the FIG. 16 example, top edge 311 is hinged. Alternatively, the top edge may facilitate or allow access to the interior cavity through any now known or later developed mechanism. The top edge may be configured as a cap or lid. Moreover, the top edge may flip, slide, or swivel to facilitate or allow access to the interior cavity.

As shown in FIG. 14, interior cavity 320 includes first side 316, second side 318 opposite first side 316, and lower edge 313 connecting first side 316 and second side 318. In the FIG. 14 example, plurality of light emitting diodes 330 are proximate to lower edge 313. Alternatively, the plurality of light emitting diodes may be aligned proximate the first side and the second side. The plurality of light emitting diodes may be configured in any location or arrangement that facilitates or allows the plurality of light emitting diodes to illuminate a document within the substantially rectangular transparent enclosure.

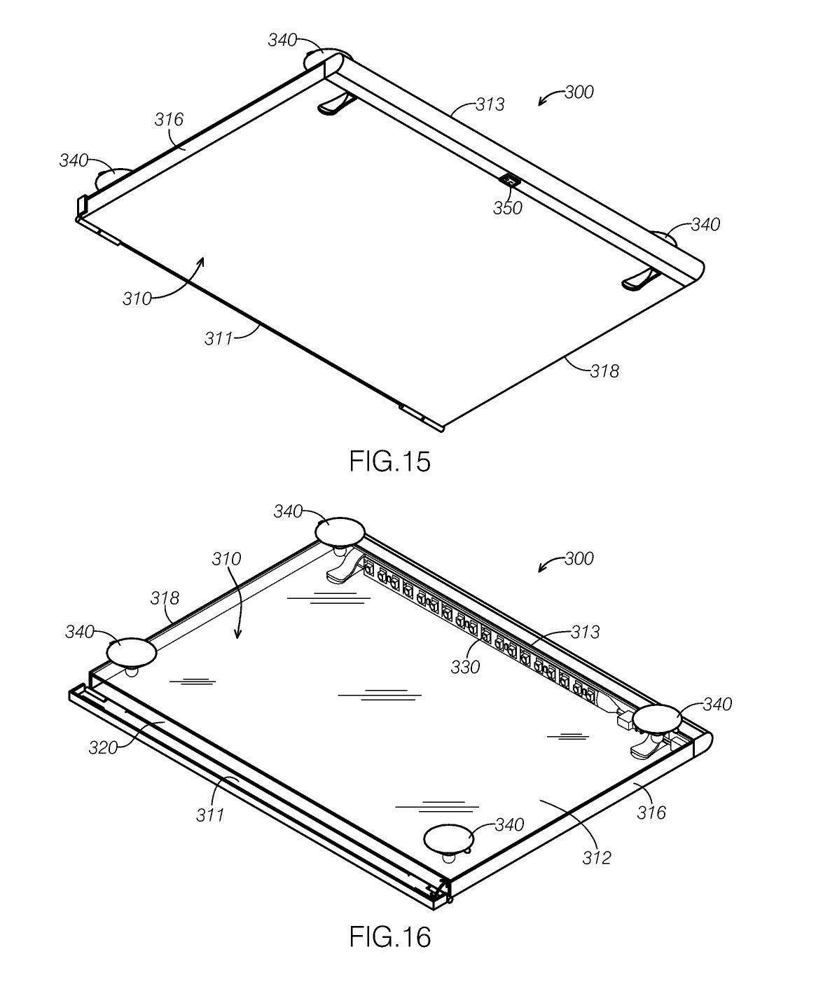

As shown in FIG. 15, substantially rectangular transparent enclosure 310 includes switch 350. Switch 350 is configured to power plurality of light emitting diodes “on” and “off.” The switch may be configured in any shape or form that facilitates or allows selectively powering the light source “on” or “off” as discussed above.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A document display system, comprising:
an enclosure including:
a first surface,
a second surface spaced from the first surface,
a top edge connecting the first surface and the second surface,
a bottom edge opposite the top edge, the bottom edge connecting the first surface and the second surface,
a first lateral side connecting the first surface, the second surface, the top edge, and the bottom edge,
a second lateral side opposite the first lateral side, the second lateral side connecting the first surface, the second surface, the top edge, and the bottom edge, and
a cavity bounded by the first surface, the second surface, the top edge, the bottom edge, the first lateral side, and the second lateral side;
a light source mounted within the cavity; and
a fastener removably attached to the first surface and configured to selectively fasten the enclosure to a window of a vehicle.

2. The document display system of claim 1, further comprising a document disposed within the cavity.

3. The document display system of claim 2, wherein the document is a temporary vehicle registration.

4. The document display system of claim 1, wherein the enclosure is plastic.

5. The document display system of claim 1, wherein the first surface is substantially transparent.

6. The document display system of claim 1, further comprising a switch mounted to the enclosure, the switch configured to power the light source on and off.

7. The document display system of claim 6, wherein the switch further includes:
a sensor configured to detect ambient daylight; and
a controller in communication with the sensor;
wherein the controller is configured to activate the switch to power the light source on when the sensor fails to detect a threshold of ambient daylight; and
wherein the controller is configured to deactivate the switch to power the light source off when the sensor detects the threshold of ambient daylight.

8. The document display system of claim 1, wherein the light source is a light emitting diode.

9. The document display system of claim 1, wherein the fastener is a suction cup.

10. A document display system, comprising:
an enclosure;
a light source mounted within the enclosure; and
a plurality of suction cup fasteners mounted to the enclosure;
wherein the plurality of suction cup fasteners are configured to selectively mount the enclosure to a window of a vehicle.

11. The document display system of claim 10, wherein the enclosure includes:
a first substantially transparent surface having a top edge, a bottom edge opposite the top edge, a first lateral side connecting the top edge and the bottom edge, and a second lateral side connecting the top edge and the bottom edge opposite the first lateral side;
a second substantially opaque surface spaced from the first substantially tranparent surface, the second substantially opaque surface having an upper edge, a lower edge opposite the upper edge, a primary lateral side connecting the upper edge and the lower edge, and a secondary lateral side connecting the upper edge and the lower edge opposite the primary lateral side; and
a cavity bounded by the first substantially transparent surface and the second substantially opaque surface;
wherein the top edge is pivotally connected to the upper edge, the first lateral side cooperatively couples with the primary lateral side, the second lateral side cooperatively couples with the secondary lateral side, and the bottom edge cooperatively couples with the lower edge.

12. The document display system of claim 10, wherein the bottom edge includes a switch configured to power the light source on and off.

13. The document display system of claim 10, wherein the switch includes a programmable timer configured to activate and deactivate the switch.

14. The document display system of claim 10, wherein the plurality of suction cup fasteners are mounted substantially near the outer edges of the first surface.

15. A document display system, comprising:
a substantially rectangular transparent enclosure defining an interior cavity;
a plurality of light emitting diodes mounted within the interior cavity; and
a plurality of fasteners mounted to an exterior surface of the enclosure;
wherein the plurality of fasteners are configured to mount the enclosure to an interior surface of a vehicle window.

16. The document display system of claim 15, further comprising a vehicle buyer's guide disposed within the interior cavity.

17. The document display system of claim 15, further comprising a sign disposed within the interior cavity.

18. The document display system of claim 15, wherein the enclosure includes a hinged top edge that provides access to the interior cavity.

19. The document display system of claim 15, wherein the interior cavity includes a first side and a second side opposite the first side.

20. The document display system of claim 19, wherein the plurality of light emitting diodes are mounted along the first side and along the second side.
